(19) United States
(12) Patent Application Publication
(10) Pub. No.: US 2025/0157736 A1
(43) Pub. Date: May 15, 2025

(54) CAPACITOR

(71) Applicants: Murata Manufacturing Co., Ltd., Nagaokakyo-shi (JP); Shizuki Electric Co., Inc., Nishinomiya-shi (JP)

(72) Inventors: Tomoki INAKURA, Nagaokakyo-shi (JP); Satoru JOGAN, Nagaokakyo-shi (JP); Kouji TAKAGAKI, Nagaokakyo-shi (JP); Yoshihito TANNO, Nishinomiya-shi (JP)

(21) Appl. No.: 19/019,914

(22) Filed: Jan. 14, 2025

Related U.S. Application Data
(63) Continuation of application No. PCT/JP2023/018374, filed on May 17, 2023.

(30) Foreign Application Priority Data
Jul. 15, 2022 (JP) 2022-113924

(51) Int. Cl. H01G 4/224; H01G 4/236; H01G 4/32

(52) U.S. Cl. CPC H01G 4/224; H01G 4/236; H01G 4/32

(57) ABSTRACT

A capacitor that includes: a capacitor element including an element body and an external electrode on an end surface of the element body; a lead-out terminal electrically connected to the external electrode; an outer case housing the capacitor element inside so that the lead-out terminal projects outward, the outer case having: a bottomed tubular shape, a guide groove constructed to regulate a position of the lead-out terminal on an inner surface of the outer case, the guide groove protruding from a side wall and extending between an opening part and a bottom wall, wherein a height of the guide groove proximal to the opening part is lower than a height of the side wall proximal to the opening part or a corner of an edge of the guide groove proximal to the opening part is chamfered.

### CROSS REFERENCE TO RELATED APPLICATIONS

The present application is a continuation of International application No. PCT/JP2023/018374, filed May 17, 2023, which claims priority to Japanese Patent Application No. 2022-113924, filed Jul. 15, 2022, the entire contents of each of which are incorporated herein by reference.

### TECHNICAL FIELD

The present disclosure relates to a capacitor

### BACKGROUND ART

As a type of capacitor, a film capacitor is known which is structured so that a flexible resin film is used as a dielectric film and metal layers facing each other with the dielectric film interposed therebetween are arranged.

The film capacitor is generally produced by a method described below. First, a capacitor element is produced by producing a laminate in which metallized films each having the metal layer on the surface of the dielectric film are wound or stacked, and then forming an external electrode (also referred to as a metallicon electrode) on each end surface of the laminate. Next, a lead-out terminal, such as a lead wire or a busbar, is attached to each of the outer surfaces of the external electrodes. The capacitor element, to which the lead-out terminals are attached, is housed in an outer case, such as a resin case, and then the case is filled with resin, followed by curing.

Patent Literature 1 and Patent Literature 2 describe that the lead-out terminals are positioned by providing guide grooves in the resin case to prevent the capacitor element from tilting in the resin case.
Patent Literature 1: JP 3-167813 A
Patent Literature 2: JP 8-64468 A

### SUMMARY OF THE DISCLOSURE

Patent Literature 1 does not describe the shape of the guide groove. Patent Literature 2 describes two different cross-sectional shapes for the shape of the guide groove but does not give a detailed description about the shape of the guide groove.

When the capacitor element is inserted into the outer case in a state where the lead-out terminals, such as lead wires, are along the guide grooves of the outer case, there is a risk that the lead-out terminals rub against the edges of the guide grooves, damaging the lead-out terminals.

It is an object of the present disclosure to provide a capacitor in which a lead-out terminal is hardly damaged when a capacitor element is inserted into an outer case in a state where the lead-out terminal is along a guide groove of the outer case.

A capacitor of the present disclosure includes: a capacitor element including an element body and an external electrode on an end surface of the element body; a lead-out terminal electrically connected to the external electrode; an outer case housing the capacitor element inside so that the lead-out terminal projects outward, the outer case having: a bottomed tubular shape with an opening part at a first end, a bottom wall sealing a second end opposite the opening part, a side wall projecting toward the opening part from the bottom wall, a guide groove constructed to regulate a position of the lead-out terminal on an inner surface of the outer case, the guide groove protruding from the side wall and extending between the opening part and the bottom wall; and a filling resin filling a space between the capacitor element and the outer case.

In a first aspect, the height of the guide groove proximal to the opening part of the outer case is lower than the height of the side wall proximal to the opening part of the outer case.

In a second aspect, the corner of an edge of the guide groove proximal to the opening part of the outer case is chamfered.

The present disclosure can provide a capacitor in which the lead-out terminal is hardly damaged when the capacitor element is inserted into the outer case in a state where the lead-out terminal is along the guide groove of the outer case.

### BRIEF DESCRIPTION OF THE DRAWINGS

FIG. 1 is a perspective view schematically illustrating a capacitor according to one embodiment of the present disclosure.

FIG. 2 is a perspective view schematically illustrating one example of a state before a capacitor element constituting the capacitor illustrated in FIG. 1 is housed in an outer case.

FIG. 3 is a perspective view schematically illustrating another example of the state before the capacitor element constituting the capacitor illustrated in FIG. 1 is housed in the outer case.

FIG. 4 is a perspective view schematically illustrating a guide groove of an outer case according to Comparative Example outside the scope of the present disclosure.

FIG. 5 is a perspective view schematically illustrating a state where a lead wire as a lead-out terminal is along the guide groove of the outer case illustrated in FIG. 4.

FIG. 6 is a perspective view schematically illustrating a guide groove of an outer case according to Example 1 within the scope of the present disclosure.

FIG. 7 is a perspective view schematically illustrating a state where the lead wire as the lead-out terminal is along the guide groove of the outer case illustrated in FIG. 6.

FIG. 8 is a side view of the outer case illustrated in FIG. 6.

FIG. 9 is a plan view of the state illustrated in FIG. 7.

FIG. 10 is a perspective view schematically illustrating a guide groove of an outer case according to Example 2 within the scope of the present disclosure.

FIG. 11 is a perspective view schematically illustrating a state where the lead wire as the lead-out terminal is along the guide groove of the outer case illustrated in FIG. 10.

FIG. 12 is a side view of the outer case illustrated in FIG. 10.

FIG. 13 is a plan view of the state illustrated in FIG. 11.

FIGS. 14A, 14B, 14C, 14D, and 14E are side views illustrating modifications of the shape between the side wall and the guide groove positioned on the opening part side of the outer case.

FIGS. 15A, 15B, 15C, 15D, 15E, and 15F are plan views illustrating modifications of the planar shape of a side of the guide groove positioned on the opening part side of the outer case.

FIG. 16 is a perspective view schematically illustrating one example of the capacitor element constituting the capacitor of the present disclosure.

FIG. 17 is a cross-sectional view along the b-b line of the capacitor element illustrated in FIG. 16.

FIG. 18 is a perspective view schematically illustrating one example of an element body constituting the capacitor element illustrated in FIGS. 16 and 17.

FIG. 19 is a perspective view schematically illustrating another example of the element body constituting the capacitor element illustrated in FIGS. 16 and 17.

### DESCRIPTION OF THE PREFERRED EMBODIMENTS

Hereinafter, a capacitor of the present disclosure is described. The present disclosure is not limited to the following configurations and may be altered as appropriate to such an extent that the gist of the present disclosure is not altered. The present disclosure also includes combinations of a plurality of individual preferable configurations described below.

In this specification, terms indicating relations between elements (e.g., “perpendicular”, “parallel”, “orthogonal”, and the like) and terms indicating the shapes of the elements are not expressions expressing only strict meanings, but expressions expressing substantially equivalent ranges, and, for example, also including about a few percent difference.

As one embodiment of the capacitor of the present disclosure, a film capacitor is described below. The capacitor of the present disclosure is also applicable to capacitors other than the film capacitor.

The drawings described below are schematic views, and the dimensions, the scales of the aspect ratios, and the like are sometimes different from those of actual products.

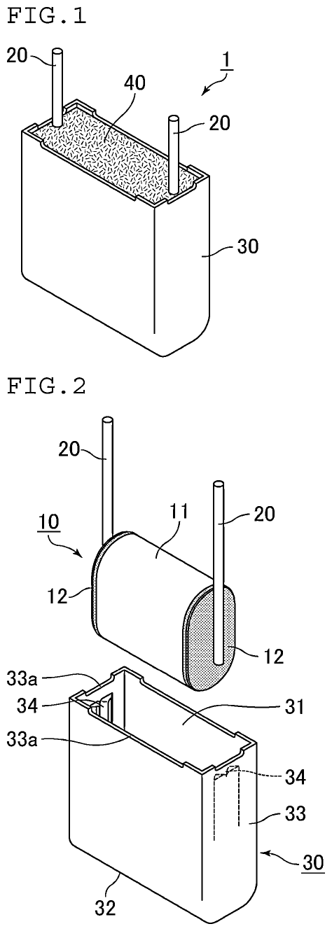

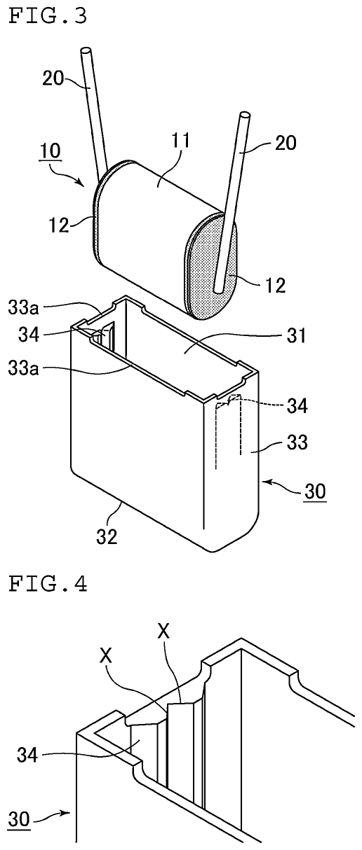

FIG. 1 is a perspective view schematically illustrating a capacitor according to one embodiment of the present disclosure. FIG. 2 is a perspective view schematically illustrating one example of a state before a capacitor element constituting the capacitor illustrated in FIG. 1 is housed in an outer case. FIG. 3 is a perspective view schematically illustrating another example of the state before the capacitor element constituting the capacitor illustrated in FIG. 1 is housed in the outer case.

A capacitor 1 illustrated in FIG. 1 includes a capacitor element 10 (see FIGS. 2 and 3), lead-out terminals 20, an outer case 30, and a filling resin 40.

The capacitor element 10 includes an element body 11 and an external electrode 12 provided on each end surface of the element body 11 as illustrated in FIGS. 2 and 3. Specifically, each of the external electrodes 12 in a pair is provided on each end surface of the element body 11.

The lead-out terminal 20 is electrically connected to the external electrode 12. Specifically, each of the lead-out terminals 20 in a pair is electrically connected to each of the external electrodes 12 in a pair.

Examples of the lead-out terminal 20 include a lead wire, a busbar, and the like. When the lead-out terminal 20 is a lead wire, the lead wire may or may not have a plated layer on the surface thereof.

In a state before the capacitor element 10 is housed in the outer case 30, each of the pair of lead-out terminals 20 may extend from each of the external electrodes 12 so that the distance between the lead-out terminals 20 is constant as illustrated in FIG. 2 or may extend from each of the external electrodes 12 so that the distance between the lead-out terminals 20 increases as illustrated in FIG. 3. On the other hand, in a state after the capacitor element 10 is housed in the outer case 30, the distance between the pair of lead-out terminals 20 is preferably constant as illustrated in FIG. 1.

As illustrated in FIGS. 1, 2, and 3, the outer case 30 houses the capacitor element 10 thereinside so that the lead-out terminals 20 project outward.

Examples of the outer case 30 include a resin case, a metal case, and the like.

In the examples illustrated in FIGS. 2 and 3, the outer case 30 has a rectangular parallelepiped space formed thereinside. Although not illustrated in FIGS. 2 and 3, the capacitor element 10 is preferably arranged in the center inside the outer case 30 while being spaced away from the inner surface of the outer case 30.

A space between the capacitor element 10 and the outer case 30 is filled with the filling resin 40. Specifically, the filling resin 40 fills a space between the outer surface of the capacitor element 10 and the inner surface of the outer case 30. The capacitor element 10 is held inside the outer case 30 by the filling resin 40.

The filling resin 40 also fills a region from an opening part 31 (see FIGS. 2 and 3) of the outer case 30 up to the capacitor element 10 inside the outer case 30.

Examples of the filling resin 40 include an epoxy resin and the like. The epoxy resin can adhesively fix the outer case 30 and the capacitor element 10 in an integral manner by being thermally cured.

The outer case 30 has a bottomed tubular shape having the opening part 31 in one end. The outer case 30 includes a bottom wall 32 sealing the other end while facing the opening part 31, and a side wall 33 projecting toward the opening part 31 from the bottom wall 32.

In the examples illustrated in FIGS. 2 and 3, the outer case 30 has a bottomed quadrangular tubular shape having the opening part 31 of a substantially rectangular shape in one end and including the bottom wall 32 sealing the other end while facing the opening part 31, and the side wall 33 of a quadrangular tubular shape projecting toward the opening part 31 from the bottom wall 32. The outer case 30 may have a shape, such as a bottomed tubular shape including the side wall 33 of a cylindrical shape in place of the side wall 33 of the quadrangular tubular shape.

As illustrated in FIGS. 2 and 3, the side wall 33 of the outer case 30 is preferably provided with a recess part 33a on the edge on the opening part 31 side. By providing the recess part(s) 33a in the opening surface of the outer case 30, when the capacitor, such as a film capacitor, is mounted on a board, an increase in internal pressure due to sealing of the capacitor and the board can be prevented. The outer case 30 does not have to be provided with the recess part(s) 33a.

As illustrated in FIGS. 2 and 3, the outer case 30 is provided with guide grooves 34 for regulating the positions of the lead-out terminals 20 on the inner surface thereof. The guide groove 34 protrudes from the side wall 33 and extends from the opening part 31 side to the bottom wall 32 side.

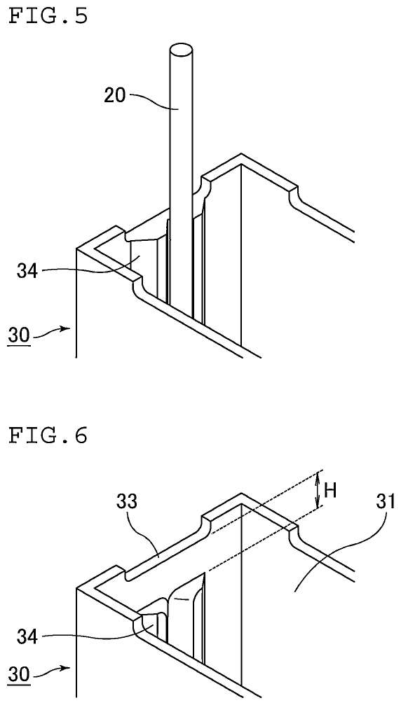

FIG. 4 is a perspective view schematically illustrating a guide groove of an outer case according to Comparative Example outside the scope of the present disclosure. FIG. 5 is a perspective view schematically illustrating a state where a lead wire as the lead-out terminal is along the guide groove of the outer case illustrated in FIG. 4.

As illustrated in FIGS. 4 and 5, when the capacitor element (not illustrated) is inserted into the outer case 30 in a state where the lead-out terminal 20, such as a lead wire, is along the guide groove 34 of the outer case 30, there is a risk that the lead-out terminal 20 rubs against the edge of the guide groove 34 (edge X of the guide groove 34 positioned on the opening part 31 side of the outer case 30 in FIG. 4), so that the lead-out terminal 20 is damaged.

In addition to the risk that the lead-out terminal 20 is damaged, the rubbing of the lead-out terminal 20 against the edge of the guide groove 34 (edge X of the guide groove 34 positioned on the opening part 31 side of the outer case 30 in FIG. 4) poses a risk that metal chips are generated form the surface of the lead-out terminal 20. In this case, the following problems are likely to occur: the metal chips are scattered to the outside of the outer case 30 and adhere to the surroundings of the capacitor or the insulation properties of the outer surface of the capacitor decrease under the influence of the scattered metal chips.

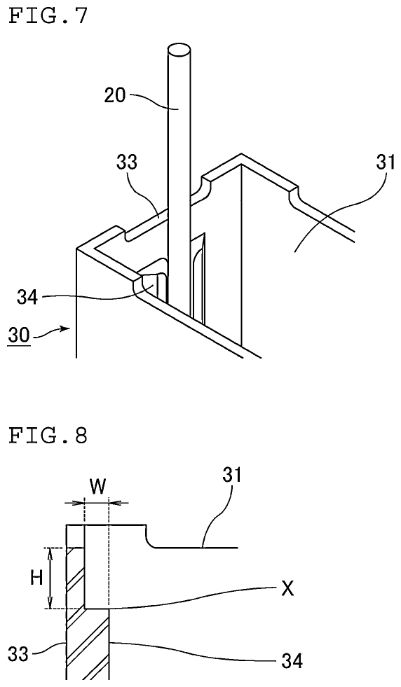

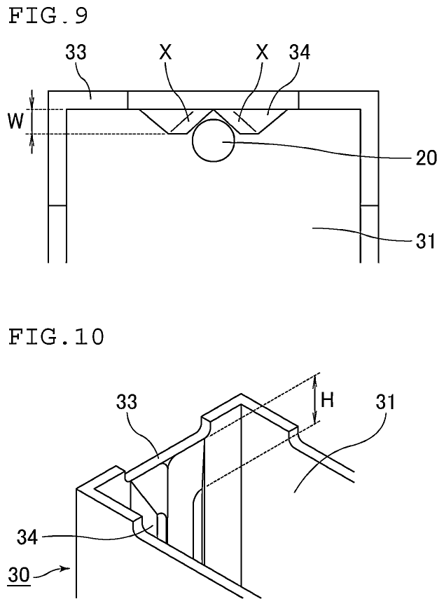

FIG. 6 is a perspective view schematically illustrating a guide groove of an outer case according to Example 1 within the scope of the present disclosure. FIG. 7 is a perspective view schematically illustrating a state where a lead wire as the lead-out terminal is along the guide groove of the outer case illustrated in FIG. 6. FIG. 8 is a side view of the outer case illustrated in FIG. 6. FIG. 9 is a plan view of the state illustrated in FIG. 7.

As a first feature, the outer case 30 illustrated in FIG. 6 is configured so that the height of the guide groove 34 positioned on the opening part 31 side of the outer case 30 is lower than the height of the side wall 33 positioned on the opening part 31 side of the outer case 30.

Specifically, the edge of the guide groove 34 positioned on the opening part 31 side of the outer case 30 (edge X of the guide groove 34 positioned on the opening part 31 side of the outer case 30 in FIGS. 8 and 9) are situated at the position lower than the edge of the side wall 33 positioned on the opening part 31 side of the outer case 30. By lowering the height of the edge of the guide groove 34 positioned on the opening part 31 side of the outer case 30 (edge X of the guide groove 34 positioned on the opening part 31 side of the outer case 30 in FIGS. 8 and 9) than the height of the edge of the side wall 33 positioned on the opening part 31 side of the outer case 30, places where the lead-out terminal 20, such as a lead wire, rubs against the edges of the guide groove 34 can be reduced. Therefore, the lead-out terminal 20 is hardly damaged when the capacitor element (not illustrated) is inserted into the outer case 30 while the lead-out terminal 20 is along the guide groove 34 of the outer case 30.

By lowering the height of the edge of the guide groove 34 positioned on the opening part 31 side of the outer case 30 than the height of the edge of the side wall 33, metal chips generated from the surface of the lead-out terminal 20 can be prevented from scattering to the outside of the outer case 30 even when the lead-out terminal 20 is damaged. This can prevent the generation of the metal chips adhering to the surroundings of the capacitor and also prevent the occurrence of creeping discharge on the surface of the capacitor.

As a second feature, the outer case 30 illustrated in FIG. 6 is configured so that the corner of the edge X of the guide groove 34 (see FIGS. 8 and 9) positioned on the opening part 31 side of the outer case 30 is chamfered.

When the capacitor element (not illustrated) is inserted into the outer case 30 while the lead-out terminal 20, such as a lead wire, is along the guide groove 34 of the outer case 30, the lead-out terminal 20 is likely to contact the edge X of the guide groove 34 positioned on the opening part 31 side of the outer case 30. Thus, the chamfering of the corner of the edge X of the guide groove 34 positioned on the opening part 31 side of the outer case 30 makes it hard for the lead-out terminal 20 to be damaged.

The corner of the edge X of the guide groove 34 positioned on the opening part 31 side of the outer case 30 is preferably R-chamfered (Round-chamfered).

In the guide groove 34, corners of edges other than the edge X of the guide groove 34 positioned on the opening part 31 side of the outer case 30 may also be chamfered. The corners of the edges in such a case are preferably R-chamfered.

When the lead-out terminal 20 is a lead wire having a plated layer on the surface thereof, for example, the rubbing of the lead-out terminal 20 against the edges of the guide groove 34 scrapes off the plated layer from the surface of the lead wire, and thus metal chips are likely to generate. The rubbing force of the lead wire becomes stronger the thicker the lead wire. Therefore, when the lead wire has an outer diameter of 1 mm, for example, the metal chips are more likely to generate. Also in such a case, the first feature or the second feature makes it hard for the lead-out terminal 20 to be damaged.

The outer case 30 illustrated in FIG. 6 has both the first feature and the second feature, but may have only the first feature or only the second feature.

In the outer case 30 illustrated in FIG. 6, a stepped surface is provided between the side wall 33 and the guide groove 34 positioned on the opening part 31 side of the outer case 30 as illustrated in FIG. 8. As illustrated in FIG. 9, when the guide groove 34 is viewed from the opening part 31 side of the outer case 30, the edge X of the guide groove 34 positioned on the opening part 31 side of the outer case 30 has a V-shaped planar shape.

As illustrated in FIGS. 6 and 8, a height difference between the side wall 33 and the guide groove 34 positioned on the opening part 31 side of the outer case 30 (length indicated by H in FIGS. 6 and 8) is, for example, 2 mm.

As illustrated in FIGS. 8 and 9, the guide groove 34 protruding from the side wall 33 has a width (length indicated by W in FIGS. 8 and 9) of 0.8 mm, for example.

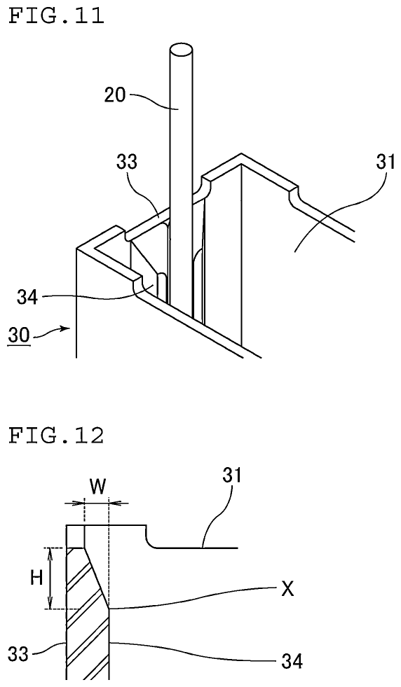

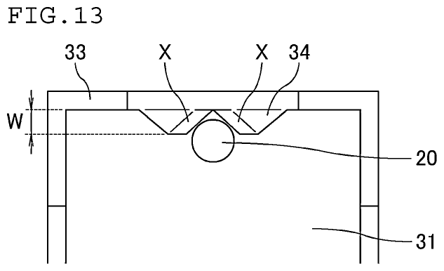

FIG. 10 is a perspective view schematically illustrating a guide groove of an outer case according to Example 2 within the scope of the present disclosure. FIG. 11 is a perspective view schematically illustrating a state where the lead wire as the lead-out terminal is along the guide groove of the outer case illustrated in FIG. 10. FIG. 12 is a side view of the outer case illustrated in FIG. 10. FIG. 13 is a plan view of the state illustrated in FIG. 11.

As a first feature, the outer case 30 illustrated in FIG. 10 is configured so that the height of the guide groove 34 positioned on the opening part 31 side of the outer case 30 is lower than the height of the side wall 33 positioned on the opening part 31 side of the outer case 30.

As a second feature, the outer case 30 illustrated in FIG. 10 is configured so that the corner of the edge X of the guide groove 34 positioned on the opening part 31 side of the outer case 30 is chamfered.

The outer case 30 illustrated in FIG. 10 also achieves the same advantageous effects as those of the outer case 30 illustrated in FIG. 6.

The outer case 30 illustrated in FIG. 10 has both the first feature and the second feature, but may have only the first feature or only the second feature.

The outer case 30 illustrated in FIG. 10 is provided with a planar inclined surface between the side wall 33 and the guide groove 34 positioned on the opening part 31 side of the outer case 30 as illustrated in FIG. 12. As illustrated in FIG. 13, when the guide groove 34 is viewed from the opening part 31 side of the outer case 30, the edge X of the guide groove 34 positioned on the opening part 31 side of the outer case 30 has a V-shaped planar shape.

As illustrated in FIGS. 10 and 12, a height difference between the side wall 33 and the guide groove 34 positioned on the opening part 31 side of the outer case 30 (length indicated by H in FIGS. 10 and 12) is, for example, 2 mm.

As illustrated in FIGS. 12 and 13, the guide groove 34 protruding from the side wall 33 has a width (length indicated by W in FIGS. 12 and 13) of 0.8 mm, for example.

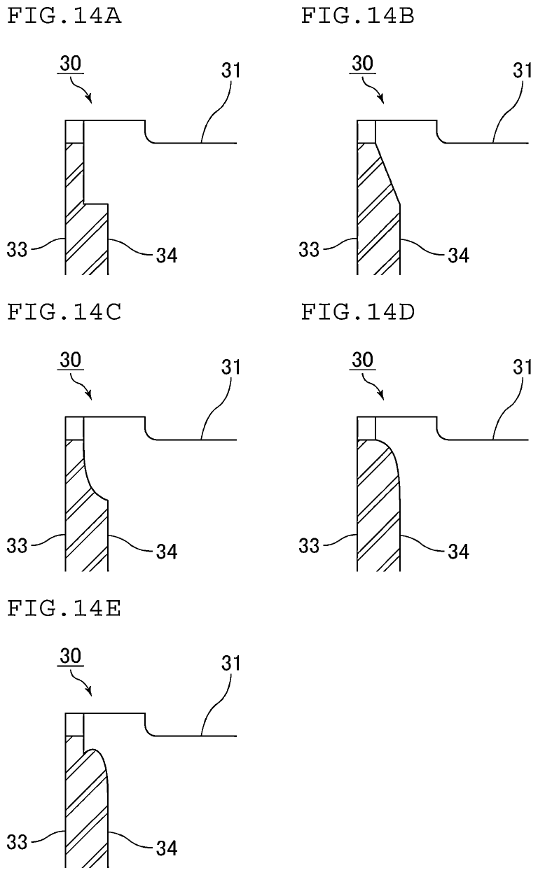

FIGS. 14A, 14B, 14C, 14D, and 14E are side views illustrating modifications of the shape between the side wall and the guide groove positioned on the opening part side of the outer case.

In the example illustrated in FIG. 14A, a stepped surface is provided between the side wall 33 and the guide groove 34 positioned on the opening part 31 side of the outer case 30. The stepped surface can effectively prevent metal chips generated from the surface of the lead-out terminal from scattering to the outside of the outer case 30. Two or more stepped surfaces may be provided between the side wall 33 and the guide groove 34 positioned on the opening part 31 side of the outer case 30.

In the example illustrated in FIG. 14B, a planar inclined surface is provided between the side wall 33 and the guide groove 34 positioned on the opening part 31 side of the outer case 30. The planar inclined surface can prevent metal chips generated from the surface of the lead-out terminal from scattering to the outside of the outer case 30 while ensuring the guiding function of the lead-out terminal. Two or more inclined surfaces may be provided between the side wall 33 and the guide groove 34 positioned on the opening part 31 side of the outer case 30.

In the examples illustrated in FIGS. 14C, 14D, and 14E, a curved inclined surface is provided between the side wall 33 and the guide groove 34 positioned on the opening part 31 side of the outer case 30. The curved inclined surface can prevent metal chips generated from the surface of the lead-out terminal from scattering to the outside of the outer case 30 while ensuring the guiding function of the lead-out terminal as with the planar inclined surface.

The curved inclined surface may project to the bottom wall 32 (not illustrated) side of the outer case 30 as illustrated in FIG. 14C or may project to the opening part 31 side of the outer case 30 as illustrated in FIG. 14D. When the inclined surface projecting to the opening part 31 side of the outer case 30 is provided as illustrated in FIG. 14D, the corners of the edge of the guide groove 34 positioned on the opening part 31 side of the outer case 30 are rounded, making it hard for the lead-out terminal to be hardly damaged.

The inclined surface projecting to the opening part 31 side of the outer case 30 may have a vertex between the side wall 33 and the guide groove 34 positioned on the opening part 31 side of the outer case 30 as illustrated in FIG. 14E. Although not illustrated, the inclined surface projecting to the bottom wall 32 side of the outer case 30 may also have a vertex between the side wall 33 and the guide groove 34 positioned on the opening part 31 side of the outer case 30.

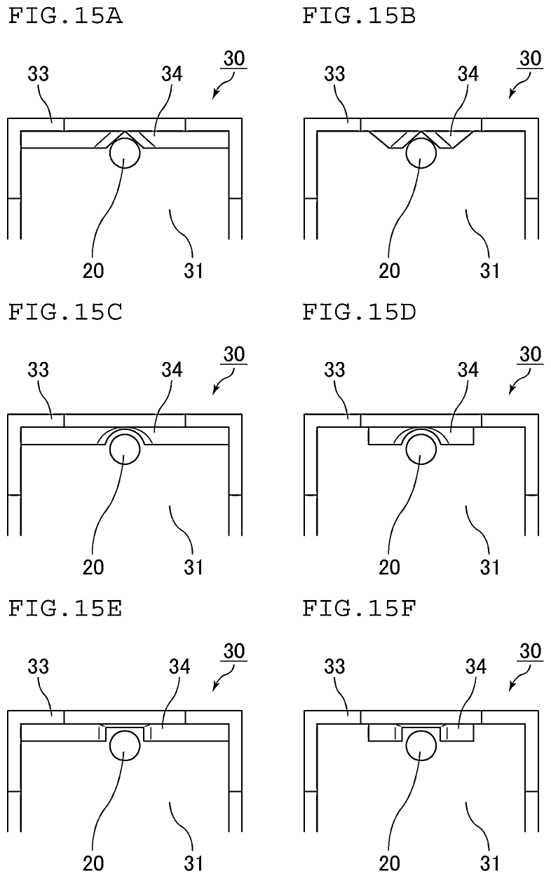

FIGS. 15A, 15B, 15C, 15D, 15E, and 15F are plan views illustrating modifications of the planar shape of the side of the guide groove positioned on the opening part side of the outer case.

In the examples illustrated in FIGS. 15A and 15B, when the guide groove 34 is viewed from the opening part 31 side of the outer case 30, the edge of the guide groove 34 positioned on the opening part 31 side of the outer case 30 has a V-shaped planar shape. As illustrated in FIGS. 15A and 15B, the range where the guide groove 34 is provided is not limited.

In the examples illustrated in FIGS. 15C and 15D, when the guide groove 34 is viewed from the opening part 31 side of the outer case 30, the edge of the guide groove 34 positioned on the opening part 31 side of the outer case 30 has a semicircular arc-shaped or semioval arc-shaped planar shape. As illustrated in FIGS. 15C and 15D, the range where the guide groove 34 is provided is not limited.

In the examples illustrated in FIGS. 15E and 15F, when the guide groove 34 is viewed from the opening part 31 side of the outer case 30, the edge of the guide groove 34 positioned on the opening part 31 side of the outer case 30 has a rectangular U-shaped (C-shaped) planar shape. As illustrated in FIGS. 15E and 15F, the range where the guide groove 34 is provided is not limited.

From the viewpoint of reducing the number of places where the lead-out terminal 20, such as a lead wire, contacts the guide groove 34, the guide groove 34 positioned on the opening part 31 side of the outer case 30 preferably has the V-shaped planar shape as illustrated in FIGS. 15A and 15B.

In the capacitor of the present disclosure, a height difference between the side wall and the guide groove positioned on the opening part side of the outer case is preferably 1 mm or more. When the height difference is 1 mm or more, metal chips generated from the surface of the lead-out terminal are hardly scattered to the outside of the outer case. The height difference between the side wall and the guide groove positioned on the opening part side of the outer case is preferably 5 mm or less. The height difference of 5 mm or less makes it easy to obtain the guiding function of the lead-out terminal.

The size of the outer case depends on the product specification to be demanded. When the height difference between the side wall and the guide groove positioned on the opening part side of the outer case falls within the range above, the height of the outer case is preferably 1.5 cm or more.

In the capacitor of the present disclosure, the outer case may also be a resin case or may also be a metal case.

When the outer case is a resin case, the resin case preferably contains a liquid crystal polymer (LCP).

As the liquid crystal polymer contained in the resin case, a liquid crystal polymer having p-hydroxybenzoic acid and a 6-hydroxy-2-naphthoic acid group in the backbone is used, for example. Further, a liquid crystal polymer is usable in which a polycondensate is formed using various components, such as phenol, phthalic acid, and ethylene terephthalate, other than p-hydroxybenzoic acid and a 6-hydroxy-2-naphthoic acid group. When the liquid crystal polymer is classified, classification methods using Type I, Type II, and Type III, for example, are used. The material means the same material as that of the liquid crystal polymer formed of the above-described constituent elements.

The resin case preferably further contains an inorganic filler in addition to the liquid crystal polymer.

As the inorganic filler contained in the resin case, materials having strength higher than that of the liquid crystal polymer are usable. The inorganic filler is preferably a material having a melting point higher than that of the liquid crystal polymer and more preferably a material having a melting point of 680° C. or more.

The form of the inorganic filler is not limited. Examples thereof include a form having a longitudinal direction, such as a fibrous form or a plate-shaped form. Two or more of these inorganic fillers may be used in combination. Thus, the resin case preferably contains a fibrous inorganic material and/or a plate-shaped inorganic material as the inorganic filler above.

In this specification, the “fibrous form” means a state where the relation between the longitudinal length of the filling material and the cross-sectional diameter in the cross-section perpendicular to the longitudinal direction satisfies Longitudinal length/Cross-sectional diameter ≥5 (i.e., aspect ratio of 5:1 or more). Herein, the cross-sectional diameter is the longest distance between two points on the periphery of the cross-section. When the cross-sectional diameter varies in the longitudinal direction, the measurement is performed at a place where the cross-sectional diameter is the largest. The “plate-shaped form” means a state where the relation between the cross-sectional diameter of the surface where the projected area is the largest and the maximum height in the direction perpendicular to this cross-section satisfies Cross-sectional diameter/Height ≥3.

The inorganic filler preferably has a portion where at least part of the inorganic filler is oriented from the bottom wall toward the opening part and a portion where at least part of the inorganic filler is oriented toward the side walls adjacent to each other in the side walls of the outer case and is preferably dispersed inside the outer case.

The inorganic filler preferably has a size of at least 5 μm or more in diameter and 50 μm or more in length. In particular, the inorganic fillers are preferably dispersed throughout the outer case without being agglomerated.

As the inorganic filler, materials, such as a fibrous glass filler, a sheet talc, or mica, are specifically usable. In particular, the inorganic filler preferably contains a glass filler as the main component.

When the outer case is the resin case, the resin case may contain polyphenylene sulfide (PPS) in place of the liquid crystal polymer.

The resin case preferably further contains the inorganic filler in addition to polyphenylene sulfide.

As the inorganic filler contained in the resin case, the same material as that in the case of the liquid crystal polymer is usable.

The resin case can be manufactured by injection molding, for example.

When the outer case is the metal case, the metal case contains single metals, such as aluminum, magnesium, iron, stainless steel, and copper, or alloys containing at least one of the metals above, for example. Among the above, the metal case preferably contains aluminum or an aluminum alloy.

The metal case can be manufactured by impact molding, for example.

In the capacitor of the present disclosure, a resin according to the required function can be selected as appropriate as the filling resin. Examples of the filling resin include an epoxy resin, a silicone resin, a urethane resin, and the like. As a curing agent for the epoxy resin, an amine curing agent and an imidazole curing agent, for example, may be used. As the filling resin, only resin may be used, and reinforcing agents may be added to enhance strength. As the reinforcing agents, inorganic fillers, such as silica and alumina, organic fillers, such as polyethylene fibers and polyamide fibers, and organic-inorganic composite fillers in which the surface of an inorganic powder is coated with an organic material, such as a silane coupling agent, for example, are used.

By filling the space between the capacitor element and the outer case with the filling resin, the capacitor element can be shielded from the open air. Therefore, it is preferable to select a resin having low moisture permeability as appropriate and thicken the resin in the opening part of the outer case.

As the thickness of the resin in the opening part of the outer case, a sufficient thickness is preferably imparted within the allowable range of the volume (bulk) of the entire capacitor. Specifically, the thickness is preferably 2 mm or more, more desirably 4 mm or more. In particular, the capacitor element is more preferably arranged to be positioned closer to the bottom wall side than the opening part side of the outer case inside the outer case, thereby making the thickness of the resin on the opening part side of the outer case larger than the thickness of the resin on the bottom wall side relative to the capacitor element.

The relation between the height of the filling resin and the height of the outer case is such that the resin in the opening part of the outer case is as thick as possible, and the filling resin may be positioned at an inner position of the outer case, may be positioned at almost the same height as the height of the outer case, or may overflow slightly due to surface tension.

When the capacitor of the present disclosure is a film capacitor, the element body constituting the capacitor element is a laminate of a metallized film including a metal layer on at least one main surface of a dielectric film, and the external electrode constituting the capacitor element is connected to the metal layer.

The laminate has, for example, a columnar shape having an oblong cross-section, and is provided with the external electrode formed, for example, by metal spraying (metallicon) on each end surface in the center axis direction.

The laminate may be a wound body in which the metallized film is wound in a stacked state.

Hereinafter, as one example of the film capacitor, a wound film capacitor is described in which the metallized films are wound in a stacked state, but a stacked film capacitor in which the metallized films are stacked may be acceptable.

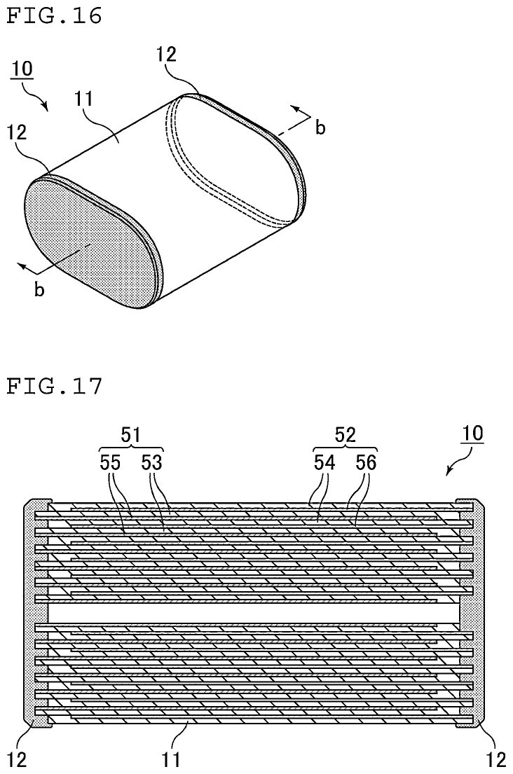

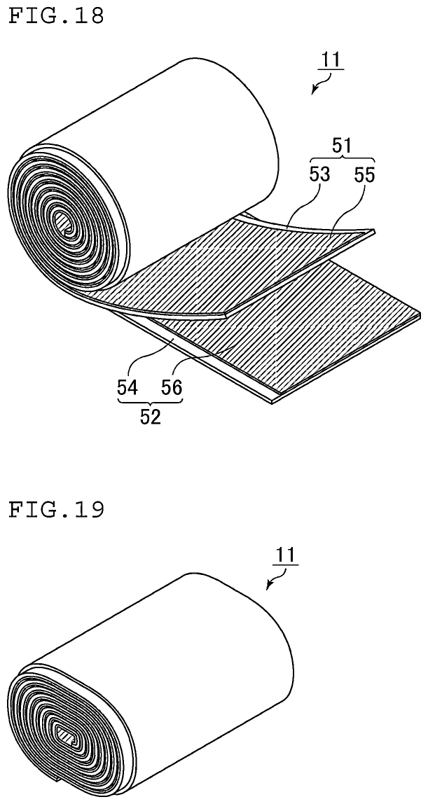

FIG. 16 is a perspective view schematically illustrating one example of the capacitor element constituting the capacitor of the present disclosure. FIG. 17 is a cross-sectional view along the b-b line of the capacitor element illustrated in FIG. 16.

In the capacitor element 10 illustrated in FIGS. 16 and 17, the element body 11 is a laminate containing a first metallized film 51 and a second metallized film 52. For example, the element body 11 is a wound body in which the first metallized film 51 and the second metallized film 52 are wound in a stacked state. To each end surface of the element body 11, each of the pair of external electrodes 12 is electrically connected.

As illustrated in FIG. 17, the first metallized film 51 includes a first dielectric film 53 and a first metal layer 55 provided on the surface of the first dielectric film 53, and the second metallized film 52 includes a second dielectric film 54 and a second metal layer 56 provided on the surface of the second dielectric film 54.

As illustrated in FIG. 17, the first metal layer 55 and the second metal layer 56 face each other with the first dielectric film 53 or the second dielectric film 54 interposed therebetween. Further, the first metal layer 55 is electrically connected to one external electrode 12, and the second metal layer 56 is electrically connected to the other external electrode 12.

The first dielectric film 53 and the second dielectric film 54 may have configurations different from each other, but preferably have the same configuration.

The first metal layer 55 is formed to reach one side edge but not to reach the other side edge on one surface of the first dielectric film 53. On the other hand, the second metal layer 56 is formed not to reach one side edge but to reach the other side edge on one surface of the second dielectric film 54. The first metal layer 55 and the second metal layer 56 are formed of an aluminum layer or the like, for example.

FIG. 18 is a perspective view schematically illustrating one example of the element body constituting the capacitor element illustrated in FIGS. 16 and 17.

As illustrated in FIGS. 17 and 18, the first dielectric films 53 and the second dielectric films 54 are stacked to be shifted in the width direction (left and right direction in FIG. 17) so that end parts reaching the side edges of the first dielectric films 53 in the first metal layers 55 and end parts reaching the side edges of the second dielectric films 54 in the second metal layers 56 are both exposed from the stacked films. As illustrated in FIG. 18, the element body 11 is formed into a wound body of the metallized films by the first dielectric films 53 and the second dielectric film 54 wound in a stacked state and is brought into a stacked state while holding the state where the first metal layers 55 and the second metal layers 56 are exposed in the end parts.

In FIGS. 17 and 18, the first metallized film 51 and the second metalized film 52 are wound so that the second dielectric film 54 is situated on the outside of the first dielectric film 53 and the first metal layer 55 and the second metal layer 56 face inward with respect to the first dielectric film 53 and the second dielectric film 54, respectively.

FIG. 19 is a perspective view schematically illustrating another example of the element body constituting the capacitor element illustrated in FIGS. 16 and 17.

When the element body 11 of the capacitor element is constituted by a wound body of the metallized films, the cross-sectional shape is preferably pressed into a flattened shape, such as an oval shape or an oblong shape, making the element body 11 more compact than that when the cross-sectional shape is a perfect circle, as illustrated in FIG. 19. In this case, the outer case can be made smaller by reducing dead space inside the outer case, and therefore the film capacitor can be made smaller as a whole.

The wound body of the metallized films may have a cylindrical winding shaft. The winding shaft is arranged on the center axis of the wound metallized films and serves as the winding shaft when the metallized films are wound.

The external electrode 12 is formed by thermal spraying, for example, zinc, onto each end surface of the element body 11 obtained as described above. One external electrode 12 contacts exposed end parts of the first metal layers 55 to be electrically connected to the first metal layers 55. The other external electrode 12 contacts exposed end parts of the second metal layers 56 to be electrically connected to the second metal layers 56.

When the capacitor of the present disclosure is the film capacitor, the dielectric film constituting the element body of the capacitor element may contain a curable resin as the main component or may contain a thermoplastic resin as the main component. From the viewpoint of enhancing the heat resistance of the film capacitor, the dielectric film preferably contains a curable resin as the main component.

In this specification, the “main component of the dielectric film” means a component having the largest weight percentage and preferably means a component having a weight percentage of more than 50% by weight. Therefore, the dielectric film may contain, as components other than main component, additives, such as a silicone resin, and uncured portions of starting materials, such as a first organic material and a second organic material, described later, for example.

The curable resin may be a thermosetting resin or a photocurable resin.

In this specification, the thermosetting resin means a resin that can be cured by heat, and a curing method is not limited. Therefore, a resin cured by methods other than heat (e.g., light, electron beams, and the like) is also included in the thermosetting resin insofar as the resin can be cured by heat. Depending on materials, a reaction sometimes starts due to the reactivity of the materials themselves, and thus materials that are cured without necessarily being exposed to external heat or light, for example, are also classified as the thermosetting resin. The same applies to the photocurable resin, and a curing method is not limited.

The curable resin may or may not have at least one of a urethane bond or a urea bond. Examples of such a resin include a urethane resin having a urethane bond, a urea resin having a urea bond, and the like. Further, a resin having both a urethane bond and a urea bond may be acceptable.

The presence of the urethane bond and/or the urea bond can be confirmed using a Fourier transform infrared spectrophotometer (FT-IR).

The curable resin preferably contains cured products of the first organic material and the second organic material. Examples of the cured product include a cured product obtained by reacting of a hydroxyl group (OH group) possessed by the first organic material with an isocyanate group (NCO group) possessed by the second organic material.

When the cured product is obtained by the reaction above, uncured portions of starting materials may remain in the film. For example, the dielectric film may contain at least one of the isocyanate group or the hydroxyl group. In this case, the dielectric film may contain either the isocyanate group or the hydroxyl group or may contain both the isocyanate group and the hydroxyl group.

The presence of the isocyanate group and/or the hydroxyl group can be confirmed using a Fourier transform infrared spectrophotometer (FT-IR).

The first organic material is preferably polyol having a plurality of hydroxyl groups in the molecule. Examples of the polyol include polyether polyol, polyester polyol, polyvinyl acetal, and other polyols. As the first organic material, two or more organic materials may be used in combination.

The second organic material is preferably an isocyanate compound, an epoxy resin, or a melamine resin, each having a plurality of functional groups in the molecule. As the second organic material, two or more organic materials may be used in combination. Among the second organic materials, the isocyanate compound is desirable.

Examples of the isocyanate compound include aromatic polyisocyanates, such as diphenylmethane diisocyanate (MDI) and tolylene diisocyanate (TDI), aliphatic polyisocyanates, such as hexamethylene diisocyanate (HDI), and the like. Modified substances of these polyisocyanates, e.g., modified substances having carbodiimide or urethane, for example, may be acceptable.

The epoxy resin is not limited insofar as it is a resin having an epoxy ring. Examples thereof include a bisphenol A-type epoxy resin, a biphenyl-backbone epoxy resin, a cyclopentadiene-backbone epoxy resin, and a naphthalene-backbone epoxy resin.

The melamine resin is not limited insofar as it is an organic nitrogen compound having a triazine ring in the center of the structure and three amino groups on the periphery of the structure. Examples thereof include an alkylated melamine resin and the like. In addition thereto, modified substances of melamine may be acceptable.

When the capacitor of the present disclosure is the film capacitor, the dielectric film constituting the element body of the capacitor element is preferably obtained by molding a resin solution containing the first organic material and the second organic material into a film, and then heat-treating the film for curing.

When the capacitor of the present disclosure is the film capacitor, the dielectric film constituting the element body of the capacitor element may contain a vapor-deposited polymerized film as the main component. The vapor-deposited polymerized film may or may not have at least one of a urethane bond or a urea bond.

The vapor-deposited polymerized film refers to one formed by a vapor deposition polymerization method, and is basically included in the curable resin.

When the capacitor of the present disclosure is the film capacitor, the dielectric film constituting the element body of the capacitor element may contain a thermoplastic resin as the main component. Examples of the thermoplastic resin include polypropylene, polyethersulfone, polyetherimide, polyarylate, and the like.

When the capacitor of the present disclosure is the film capacitor, the dielectric film constituting the element body of the capacitor element can also contain additives for adding other functions. For example, smoothness can be imparted by adding a leveling agent. The additives are more preferably materials having a functional group reacting with the hydroxyl group and/or the isocyanate group and forming part of the crosslinked structure of the cured product. Examples of such materials include a resin having at least one functional group selected from the group consisting of an epoxy group, a silanol group, and a carboxyl group and the like.

When the capacitor of the present disclosure is the film capacitor, the thickness of the dielectric film constituting the element body of the capacitor element is not limited, and may be set as appropriate according to the required capacitance and the required element volume of the capacitor to be produced.

The thickness of the dielectric film can be measured using an optical thickness gauge.

When the capacitor of the present disclosure is the film capacitor, the kind of the metal contained in the metal layer constituting the element body of the capacitor element is not limited. The metal layer preferably contains any one selected from the group consisting of aluminum (Al), titanium (Ti), zinc (Zn), magnesium (Mg), tin (Sn), and nickel (Ni).

When the capacitor of the present disclosure is the film capacitor, the thickness of the metal layer constituting the element body of the capacitor element is not limited. From the viewpoint of suppressing damage to the metal layer, the metal layer preferably has a thickness of 5 nm to 40 nm.

The thickness of the metal layer can be specified by observing a cross-section of the metallized film cut in the thickness direction using an electron microscope, such as a field emission scanning electron microscope (FE-SEM).

The capacitor of the present disclosure is not limited to the embodiments above insofar as the height of the guide groove positioned on the opening part side of the outer case is lower than the height of the side wall positioned on the opening part side of the outer case or the corner of the edge of the guide groove positioned on the opening part side of the outer case is chamfered. Therefore, various applications and modifications can be made to the configuration, manufacturing conditions, and the like of the capacitor within the scope of the present disclosure.

In the film capacitor of the present disclosure, when each of the pair of external electrodes is provided on each end surface of the element body and each of the pair of lead-out terminals is electrically connected to each of the pair of external electrodes, at least one lead-out terminal and the guide groove for regulating the position of the lead-out terminal may satisfy the relation described in the embodiment above.

FIG. 1 illustrates the example in which a single capacitor element is housed in a single outer case. However, as described in, for example, JP 2012-69840 A, a plurality of capacitor elements may be housed in a single outer case.

In the capacitor of the present disclosure, a portion where the lead-out terminal, such as a lead wire, is electrically connected to the external electrode of the capacitor element is provided in a small region of the external electrode, and therefore, when load is applied to the lead-out terminal, there is a risk that the lead-out terminal is disconnected from the external electrode. Therefore, inside the outer case, the filling resin is preferably positioned on the outside of the lead-out terminal and the external electrode of the capacitor element and closely fixes the external electrode and the lead-out terminal. Thus, even when load is applied to a projection part of the lead-out terminal, the filling resin reinforces the connection between the lead-out terminal and the external electrode, and can suppress the disconnection between the lead-out terminal and the external electrode.

The connection position between the external electrode and the lead-out terminal is not limited, and may be, for example, situated on the bottom side of the case as illustrated in FIG. 2 or FIG. 3, on the opening part side of the case as illustrated in FIG. 1 of JP 4733566 B, or in a center part of the external electrode.

This specification discloses the following items.

<1> A capacitor includes: a capacitor element including an element body and an external electrode on an end surface of the element body; a lead-out terminal electrically connected to the external electrode; an outer case housing the capacitor element inside so that the lead-out terminal projects outward, the outer case having: a bottomed tubular shape with an opening part at a first end thereof, a bottom wall sealing a second end while facing the opening part, a side wall projecting toward the opening part from the bottom wall, a guide groove constructed to regulate a position of the lead-out terminal on an inner surface of the outer case, the guide groove protruding from the side wall and extending between the opening part and the bottom wall, wherein a height of the guide groove proximal to the opening part of the outer case is lower than a height of the side wall proximal to the opening part of the outer case; and a filling resin filling a space between the capacitor element and the outer case.

<2> The capacitor according to <1>, in which a corner of an edge of the guide groove proximal to the opening part of the outer case is chamfered.

<3> A capacitor includes: a capacitor element including an element body and an external electrode on an end surface of the element body; a lead-out terminal electrically connected to the external electrode; an outer case housing the capacitor element inside so that the lead-out terminal projects outward, the outer case having: a bottomed tubular shape with an opening part at a first end thereof, a bottom wall sealing a second end while facing the opening part, a side wall projecting toward the opening part from the bottom wall, a guide groove constructed to regulate a position of the lead-out terminal on an inner surface of the outer case, the guide groove protruding from the side wall and extending between the opening part and the bottom wall, and a corner of an edge of the guide groove proximal to the opening part of the outer case is chamfered; and a filling resin filling a space between the capacitor element and the outer case.

<4> The capacitor according to <1> or <2>, in which a stepped surface is defined between the side wall and the guide groove proximal to the opening part of the outer case.

<5> The capacitor according to <1> or <2>, in which a planar inclined surface is defined between the side wall and the guide groove proximal to the opening part of the outer case.

<6> The capacitor according to <1> or <2>, in which a curved inclined surface is defined between the side wall and the guide groove proximal to the opening part of the outer case.

<7> The capacitor according to any one of <1> to <6>, in which, when the guide groove is viewed from the opening part of the outer case, the edge of the guide groove has a V-shaped planar shape.

<8> The capacitor according to any one of <1> to <6>, in which, when the guide groove is viewed from the opening part of the outer case, the edge of the guide groove has a semicircular arc-shaped or semioval arc-shaped planar shape.

<9> The capacitor according to any one of <1> to <6>, in which, when the guide groove is viewed from the opening part of the outer case, the edge of the guide groove has a rectangular U-shaped planar shape.

<10> The capacitor according to any one of <1> to <9>, in which the lead-out terminal is a lead wire having a plated layer on the surface thereof.

<11> The capacitor according to <10>, in which the lead wire has an outer diameter of 1 mm or more.

<12> The capacitor according to any one of <1> to <11>, in which the outer case is a resin case.

<13> The capacitor according to <12>, in which the resin case contains a liquid crystal polymer.

<14> The capacitor according to any one of <1> to <13>, in which the element body is a laminate of a metallized film including a metal layer on at least one main surface of a dielectric film, and the external electrode is connected to the metal layer.

<15> The capacitor according to <14>, in which the laminate is a wound body.

### REFERENCE SIGNS LIST

1 capacitor
10 capacitor element
11 element body
12 external electrode
20 lead-out terminal
30 outer case
31 opening part
32 bottom wall
33 side wall
33a recess part
34 guide groove
40 filling resin
51 first metallized film
52 second metallized film
53 first dielectric film
54 second dielectric film
55 first metal layer
56 second metal layer
H height difference between side wall and guide groove positioned on opening part side of outer case
W width of guide groove protruding from side wall
X edge of guide groove positioned on opening part side of outer case

1. A capacitor comprising:
a capacitor element including an element body and an external electrode on an end surface of the element body;
a lead-out terminal electrically connected to the external electrode;
an outer case housing the capacitor element inside so that the lead-out terminal projects outward, the outer case having:
a bottomed tubular shape with an opening part at a first end thereof,
a bottom wall sealing a second end while facing the opening part,
a side wall projecting toward the opening part from the bottom wall,
a guide groove constructed to regulate a position of the lead-out terminal on an inner surface of the outer case, the guide groove protruding from the side wall and extending between the opening part and the bottom wall, wherein
a height of the guide groove proximal to the opening part of the outer case is lower than a height of the side wall proximal to the opening part of the outer case; and
a filling resin filling a space between the capacitor element and the outer case.

2. The capacitor according to claim 1, wherein a corner of an edge of the guide groove proximal to the opening part of the outer case is chamfered.

3. The capacitor according to claim 1, wherein a stepped surface is defined between the side wall and the guide groove proximal to the opening part of the outer case.

4. The capacitor according to claim 1, wherein a planar inclined surface is defined between the side wall and the guide groove proximal to the opening part of the outer case.

5. The capacitor according to claim 1, wherein a curved inclined surface is defined between the side wall and the guide groove proximal to the opening part of the outer case.

6. The capacitor according to claim 1, wherein when the guide groove is viewed from the opening part of the outer case, an edge of the guide groove has a V-shaped planar shape.

7. The capacitor according to claim 1, wherein when the guide groove is viewed from the opening part of the outer case, an edge of the guide groove has a semicircular arc-shaped or semioval arc-shaped planar shape.

8. The capacitor according to claim 1, wherein when the guide groove is viewed from the opening part of the outer case, an edge of the guide groove has a rectangular U-shaped planar shape.

9. The capacitor according to claim 1, wherein the lead-out terminal is a lead wire having a plated layer on a surface thereof.

10. The capacitor according to claim 9, wherein the lead wire has an outer diameter of 1 mm or more.

11. The capacitor according to claim 1, wherein the outer case is a resin case.

12. The capacitor according to claim 11, wherein the resin case contains a liquid crystal polymer.

13. The capacitor according to claim 1,
wherein the element body is a laminate of a metallized film including a metal layer on at least one main surface of a dielectric film, and
the external electrode is connected to the metal layer.

14. The capacitor according to claim 13, wherein the laminate is a wound body.

15. A capacitor comprising:
a capacitor element including an element body and an external electrode on an end surface of the element body;
a lead-out terminal electrically connected to the external electrode;
an outer case housing the capacitor element inside so that the lead-out terminal projects outward, the outer case having:
a bottomed tubular shape with an opening part at a first end thereof,
a bottom wall sealing a second end while facing the opening part,
a side wall projecting toward the opening part from the bottom wall,
a guide groove constructed to regulate a position of the lead-out terminal on an inner surface of the outer case, the guide groove protruding from the side wall and extending between the opening part and the bottom wall, and a corner of an edge of the guide groove proximal to the opening part of the outer case is chamfered; and
a filling resin filling a space between the capacitor element and the outer case.

16. The capacitor according to claim 15, wherein when the guide groove is viewed from the opening part of the outer case, an edge of the guide groove has a V-shaped planar shape.

17. The capacitor according to claim 15, wherein when the guide groove is viewed from the opening part of the outer case, an edge of the guide groove has a semicircular arc-shaped or semioval arc-shaped planar shape.

18. The capacitor according to claim 15, wherein when the guide groove is viewed from the opening part of the outer case, an edge of the guide groove has a rectangular U-shaped planar shape.

19. The capacitor according to claim 15,
wherein the element body is a laminate of a metallized film including a metal layer on at least one main surface of a dielectric film, and
the external electrode is connected to the metal layer.

20. The capacitor according to claim 19, wherein the laminate is a wound body.
